(19) United States
(12) Patent Application Publication
(10) Pub. No.: US 2005/0168748 A1
(43) Pub. Date: Aug. 4, 2005

(54) System and method for investigating photon or particle trajectory and interference pattern formation in double slit experiments

(76) Inventor: James D. Welch, Lincoln, NE (US)

Correspondence Address: JAMES D. WELCH, 10328 PINEHURST AVE., OMAHA, NE, 68124, US

(21) Appl. No.: 10/844,839

(22) Filed: May 13, 2004

Related U.S. Application Data
(60) Provisional application No. 60/541,485, filed on Feb. 3, 2004.
(60) Provisional application No. 60/555,347, filed on Mar. 22, 2004.
(60) Provisional application No. 60/568,876, filed on May 6, 2004.

(51) Int. Cl. G01B 9/02

(52) U.S. Cl. 356/450

(57) ABSTRACT

A system and method for providing insight as to which slit of a double slit system a photon or particle passes through in formation of an interference pattern, without destroying the interference pattern.

This Application Claims benefit of Provisional Applications Ser. Nos. 60/541,485 Filed Feb. 3, 2004, 60/555,347, Filed Mar. 22, 2004 and 60/568,876, Filed May 6, 2004.

### TECHNICAL AREA

The present invention relates to production of interference patterns by causing photons or particles to pass through closely spaced double slits and impinge on a screen, and more particulalry to system and method for investigating which slit the photon or particle passes without destroying said interference pattern.

### BACKGROUND

It is generally well known that when a beam of photons is caused to flow from a source located to one side of a barrier which has two closely situated slits therein, then an interference pattern can form and be observed on a screen at some distance beyond said barrier. This is true unless one attempts to determine which slit a photon passes through. If one attempts to determine which slit a photon passes through, it is generally found that the interference pattern is altered to an extent directly related to success attained in determining through which slit a specific photon passed. Typically any attempt to determine which slit a photon passes through completely destroys the interference pattern. The same situation is observed when the flow of photons is replaced with a flow of electrons. It is generally agreed that it is impossible to know both momentum and position of a particle under Heisenberg's Uncertianty Principal:
Δp*Δx>=h,
where “h” is plank's constant.

For insight it is recited that for moving particles, the deBroglie wavelength thereof is given by dividing Plank's Constant by momentum:
Wavelength=h/p;
where h is again Plank's Constant 6.626×10⁻³⁴ J-sec, and “p” is momentum. Also for reference, the rest mass of an electron is 9.11×10-31 Kg, and the mass of a Proton is about 1800 times as large. Further for a Double Slit arrangement, the Interference Pattern is characterized by:
H×Sin(θ)=#×wavelength; and
as Sin(θ) is approximately Y/X, the position “Y” on a Screen where a photon or particle impinges after passing through Double Slits which are Spaced apart by “H”, and at which is present a peak intensity, is approximately:

$$Y = \frac{\# \times Wavelength \times X}{H} ;$$

where “X” is the distance of the Screen from said Double Slits, and where “Y” is the distance from the perpendicular intersection of the Screen by a line taken from the mid-point between the Double Slits which is perpendicular to the Plane of said Double Slits, and # is an Integer.

While countless many references are available which describe the Young's Double Slit Experiment one is is:
“The Feynman Lectures on Physics”, Copyright California Institute of Technology (1965)), Addison-Wesley Publishing, (1965).
   Another reference which describes the relationship of the Double Slit experiment to Entangled Photons or Particles is:
“Entangled”, Aczell, Raincoast Books, (2002).
   Also, “Quantum Mechanics” by Albert Messiah is identified as it mentions the topic of conducting the Double Slit experiment in a Cloud Chamber and dismisses it based on momentum uncertainty in the ionization processes. However, no experimental evoidence is provided to prove the statement, and no insight is provided to detecting photons or particles which reflect from or refract through a Primary screen upon which an Interference Pattern is formed, by a supplemental detector, to identify the angle at which they approach.

A Computer Key-Word Patent Search provided no results.

### DISCLOSURE OF THE INVENTION

The disclosed invention provides that photons or particles which impinge upon a Primary screen after passing through a Double Slit form an interference pattern and can undergo reflection and/or refraction by interaction with said Primary screen. Monitoring the reflected and/or refracted photon or particle can provide insight as to which of the Two Slits the photon or particle passes based upon the well known relationships of:
Angle-of-Reflection=Angle-of-Incidence; and Snell's Law for Refraction.

It is noted that experiments have been conducted by others wherein sources and detectors of photons have been placed near slits in a double slit apparatus barrier, with the hope being that when an electron passed through a specific slit then a detector placed to receive photons directed at and reflected therefrom would so indicate it. The high energy, (high frequency short wavelength), required of a photon necessary to monitor a particle the size of an electron, however, affects the end result. That is, if one detects which slit the electron passed through, then the interference pattern is distorted or even destroyed, (see of Feynman Lectures on Physics Vol. 3, Addison Wesley, Copyright California Institute of Technology (1965)).

The disclosed invention is a method of investigating formation of an interference pattern formed on a screen caused by flowing photons or particles at a barrier which comprises two closely situated slits therein; comprising the steps of:
a) providing a system comprising sequentially:
   a source of photons or particles;
   a barrier comprising two closely situated slits therein;
   a pattern screen; and
   at least a supplemental screen;
      such that in use photons or particles are caused to flow from said source of photons or particles toward said barrier comprising two closely situated slits therein, such that at least some of said flowing photons or particles pass through one or the other slit and impinge upon said screen;
b) causing at least one photon or particle to flow from said source of photons or particles toward said barrier so that it passes through one of said closely spaced slits and impinges on said screen to form an interference pattern;
c) further monitoring the location on a supplemental screen whereupon photon or particle reflected or refracted from the screen arrives; and
d) from well known angle-of-reflection is equal to angle-of-incidence and/or Snell's Law of refraction, determine which slit said at least one photon or particle passed.

It is known that photons or particles can be caused to flow one at a time, and the interference pattern still develops over time.

Further, while not limiting, the photons or particles can be selected from the group consisting of:
photons;
electrons;
positrons;
protons;
neutrons;
atoms
ionized atoms; and
molecules.
   It is to be understood that the screen can comprise a multi-element detector, a means for supporting a film sensitive to the impact of said photon or particle and a flim sensitive to said impact or functional equivalent, wherein the function performed comprises documenting where the photon or particle impinges thereupon. For instance, a high energy photon could interact with a thin layer of organic material on a Primary screen and detectably polymerize it at the location of impact, and then reflect therefrom, (with reduced energy), and travel to a supplemental detector. As the Angle-of-Incidence will equal the Angle-of-Reflection it will be possible to determine which Slit the photon went through. If the Primary screen is transparent, the photon or particle can be refracted into arriving at a Supplemental Screen. Again, the amount of refraction will indicate which Slit it went through.

The present invention will be better understood by reference to the Detailed Description of this Specification, in combination with reference to the Drawings.

### SUMMARY OF THE INVENTION

It is therefore an objective and/or purpose of the disclosed invention to teach a method of investigating the etiology of an interference pattern formed on a pattern screen caused by flowing photons or particles at a barrier which comprises two closely situated slits therein.

Other objectives and/or purposes of the disclosed invention will become apparent by a reading of the Specification and Claims.

### BREIF DESCRIPTION OF THE DRAWINGS

FIG. 1a demonstrates a Primary screen can be comprised of a Substrate with a thin layer of Emulsion on its surface. Supplemental Screens (SC′) and (SC″) can be of similar construction or comprise electronic photon or particle detectors.

FIG. 1b shows a Primary screen (SC) can be comprised of a Reflective Substrate (SUB) with a First thin layer of Emulsion (EMU) on one surfaces and Second thin layer of Emulsion (EMU′) on its opposte surface.

FIG. 2 demonstrates that a photon passing through Slit (S1) will reflect from the Primary screen (SC) at a different Angle than will one passing through Slit (S2) and arrive at Supplemental Screen (S′) at a different location thereupon.

FIG. 3 demonstrates that a photon passing through Slit (S1) will refract through the Primary screen (SC) at a different Angle than will one passing through Slit (S2) and arrive at Supplemental Screen (S″) at a different location thereupon.

FIG. 4 pictorially demonstrates Angle-of Incidence=Angle-of-Reflection, and Snell's law of refraction.

### DETAILED DESCRIPTION

As described in the Background Section, for a Double Slit (S1) (S2) arrangement, the Interference Pattern formed at a Primary screen (SC) is characterized by:
H×Sin(θ)=p×wavelength; and
as Sin(θ) is approximately Y/X, the position “Y” on a Primary screen where a photon or particle impinges after passing through Double Slits, which are Spaced apart by “H” is

$$Y = \frac{p \times Wavelength \times X}{H} ;$$

where “X” is the distance of the Primary screen from said Double Slits, and where “Y” is the distance from the perpendicular intersection of the Primary screen by a line taken from the mid-point between the Double Slits which is perpendicular to the Plane of said Double Slits. The present invention obeys said teachings.

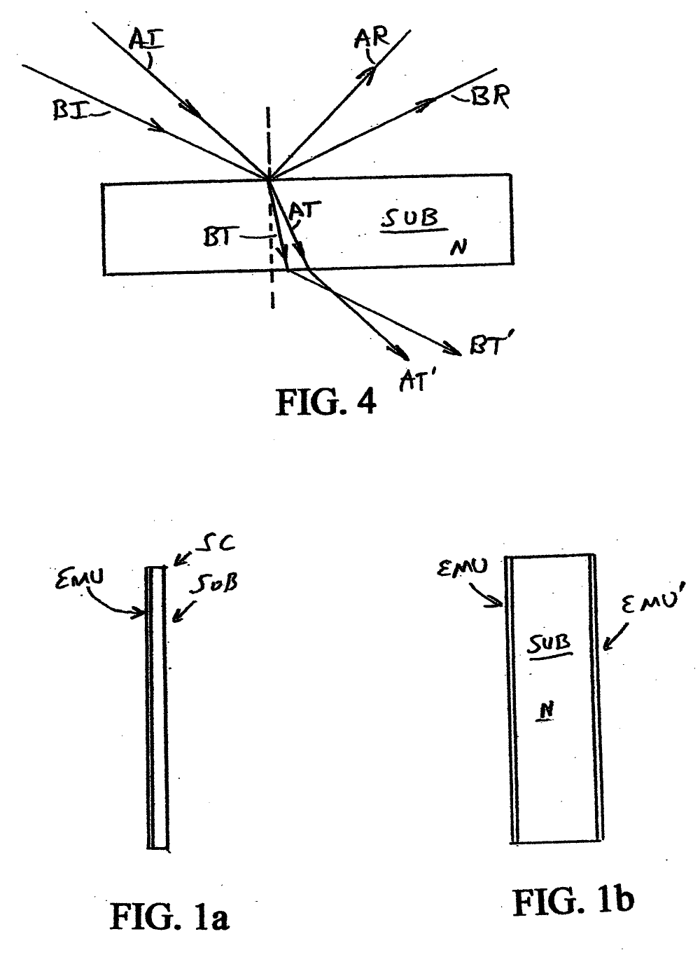

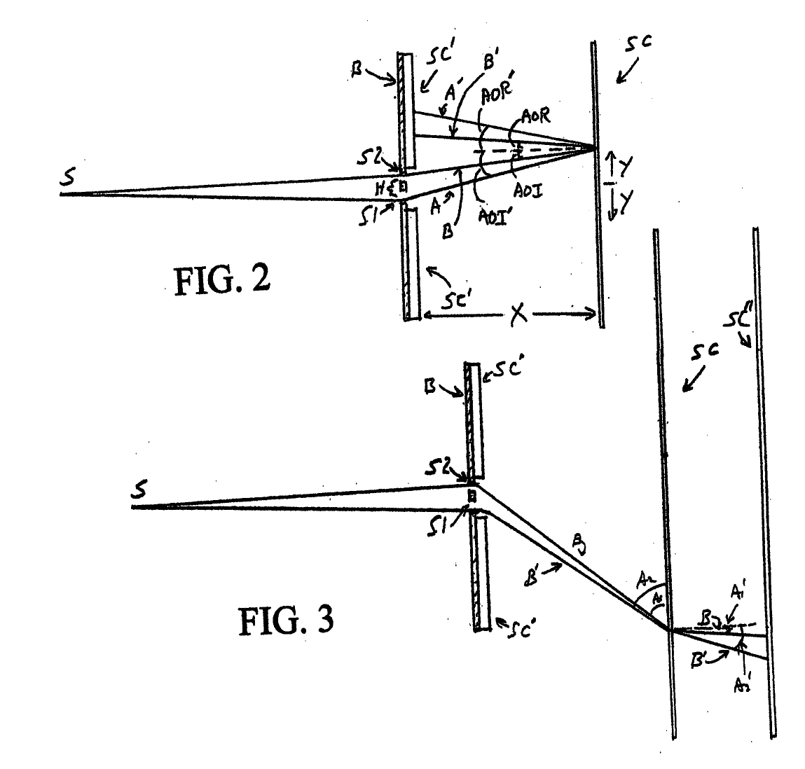

FIG. 1a demonstrates a Primary screen (SC) can be comprised of a Reflective Substrate (SUB) with a thin layer of Emulsion (EMU) on its surface. (Note, (EMU) can indicate an array of photon or particle detector elements). Any functional means for documenting the arrival of a photon or particle at the Primary screen (SC), and as demonstrated, the Primary screen can be reflective or transparent, perhaps at different wavelengths.
FIG. 1b shows a Primary screen (SC) can be comprised of a Reflective Substrate (SUB) with a First thin layer of Emulsion (EMU) on one surfaces and Second thin layer of Emulsion (EMU′) on its opposte surface. (Note, one or both (EMU) or (EMU′) can be replaced by an array of photon or particle detector elements or any functional means for documenting the arrival of a photon or particle at the Primary screen (SC)). The Primary screen can be reflective or transparent, perhaps at different wavelengths, but said FIG. 1b embodiment is primarily useful in wavelength ranges where the Substrate (SUB) is transparent and has an Index of Refraction (n) which causes photons or particles arriving at the First thin layer of Emulsion (EMU) to follow a Snell's Law governed refracted pathway therethrough to the second Thin layer of Emulsion (EMU′), which pathway depends on the Angle-of-Incidence along which the photon or particle arrived at the First thin layer of Emulsion (EMU).
FIG. 2 demonstrates that a photon passing through Slit (S1) and interacting with Primary screen (SC) will reflect therefrom at a different Angle than will one passing through Slit (S2), to maintain Angle-of-Incidence=Angle-of-Reflection. If a photon or particle passes through Slit (S1) or (S2) and arrives at the Primary screen (SC) as shown, then interacts therewith to leave a detectable marking, then reflects and is intercepted by Supplemental Screen (SC′), the position of its impact with Supplemental Screen (SC′) will be defined by path “A” or “B”, thereby indicating which Slit (S1) or (S2) the photon or particle passed.
FIG. 3 demonstrates that a photon passing through Slit (S1) will refract through the Primary screen (SC) at a different Angle than will one passing through Slit (S2) as described by Snell's Law:
   Sin(θA1)/Sin(θA2)=N2/N1.
   The impact with Supplemental Screen (SC″) depends on which path “A′” or “B′” the photon or particle traveled, (ie. whch Slt (S1) or (S2) it passed through.

The Slit Spacing “H”, as well as the distances “X” and “Y” are indicated in FIG. 2. It is noted that Distances “X” and “H” can be adjusted to increase the “Y” spacing of an Interference Pattern Peaks on the Primary Screen (SC), as can the effective photon or particle momentum. Further, the Supplemental Screesn (SC′) (SC″) can be placed at various distances from the Primary Screen (SC), and need not be oriented as shown. For instance, they might be placed at an angle to improve offset between where “A” and “B” or “A′” and “B′” intersect Supplemental Screens (S′) and (S″) respectively.

It should be appreciated that the disclosed invention is no different from existing proven workable Double Slit Systems for use in producing an Interference Pattern up to the point of the Primary Screen (SC). The present invention however, requires that said Primary Screen (SC) be functionally reflective and/or transmissive and adds Supplemental Screens (SC′) and/or SC″) to detect photons or particles which reflect from or diffract through the Primary Screen (SC).
FIGS. 2 and 3 each demonstrate loci for a single photon or particle. Other photons or particles will randomly approach the Primary Screen (SC) along other loci. When a sufficient number of photons or particles have impinged upon the S

FIG. 4 pictorially demonstrates Angle-of Incidence=Angle-of-Reflection and Snell's law of refraction. Two photon or particle Angle-of-Incidence loci (AI) (BI) with respect to the a surface of a Substrate (SUB) are shown, along with reflected Angle-of-Reflection (AR) (BR) loci, and Angle-of-Refraction (AT) (BT) loci. Also indicated are photon or particle loci leaving the Substrate (SUB). The point to be taken is that the loci of reflected and refracted particles can be determined.

The terminology primary “screen” as used herein to identify where an interference pattern is formed is to be considered to include multi-element detectors, films sensitive to impact by photons or particles, or any functional equivalent.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

1. A method of investigating formation of an interference pattern formed on a screen caused by flowing photons or particles at a barrier which comprises two closely situated slits therein; comprising the steps of:
a) providing a system comprising sequentially:
a source of photons or particles;
a barrier comprising two closely situated slits therein;
a primary screen; and
at least one supplemental screen;
such that in use photons or particles are caused to flow from said source of photons or particles toward said barrier comprising two closely situated slits therein, such that at least some of said flowing photons or particles pass through one or the other slit and impinge upon said screen;
b) causing at least one photon or particle to flow from said source of photons or particles toward said barrier so that it passes through one of said closely spaced slits and impinges on said screen to form an interference pattern;
c) further monitoring the location on a supplemental screen whereupon reflected and/or refracted photon or particle arrives; and
d) from well known angle-of-reflection is equal to angle-of-incidence and/or Snell's Law of refraction, determine which slit said at least one photon or particle passed.

2. A method as in claim 1, in which said sufficient photons or particles are caused to flow one at a time.

3. A method as in claim 1, in which the photons or particles caused to flow in step b are selected from the group consisting of:
photons;
electrons;
positrons;
protons;
neutrons;
atoms;
ionized atoms; and
molecules.
and the two closely situated slits are separated by a distance which can be resolved by optical means.

4. A method as in claim 1, in which the primary or supplemental screen comprises a multi-element detector.

5. A method as in claim 1, in which the primary screen comprises a means for supporting a film sensitive to the impact of said photon or particle and a flim sensitive to said impact.

6. A method as in claim 1, in which the primary screen comprises a sequence of a layer sensitive to impact by a photon or particle, a base layer with a known index of refraction and a second layer sensitive to impact by a photon or particle, said second layer comprising said supplemental screen.

7. A method as in claim 1, in which during the step b causing of at least one photon or particle to flow from said source of photons or particles toward said barrier to the end that at least one photon or particle passes through one of said closely spaced slits and impinges on said screen; unintended electromagnetic radiation is prevented accress to the system for producing an interference pattern.

8. A system comprising sequentially:
a source of photons or particles;
a barrier comprising two closely situated slits therein;
a primary screen; and
at least one supplemental screen;
such that in use photons or particles are caused to flow from said source of photons or particles toward said barrier comprising two closely situated slits therein, such that at least some of said flowing photons or particles pass through one or the other slit and impinge upon said primary screen and then reflect or refract and impinge upon a supplemental screen as governed by:
angle-of-incidence=angle-of-reflection, or
Snell's law of refraction.
